(19) United States
(12) Patent Application Publication
(10) Pub. No.: US 2024/0241462 A1
(43) Pub. Date: Jul. 18, 2024

(54) ELECTROSTATIC COLLECTING APPARATUS, IMAGE FORMING APPARATUS, AND CLEANING APPARATUS

(71) Applicant: CANON KABUSHIKI KAISHA, Tokyo (JP)

(72) Inventors: YUKI NISHIZAWA, Kanagawa (JP); TOMOAKI NAKAI, Shizuoka (JP)

(21) Appl. No.: 18/402,002

(22) Filed: Jan. 2, 2024

(30) Foreign Application Priority Data
Jan. 12, 2023 (JP) 2023-003215

(51) Int. Cl. G03G 15/02

(52) U.S. Cl. CPC G03G 15/0233; G03G 15/0283; G03G 15/0291

(57) ABSTRACT

An electrostatic collecting apparatus includes: a collecting rotating member rotatably arranged opposed to a surface of an object to be cleaned and to which a substance to be collected attaches; an adsorption force generating unit for generating an electrostatic adsorption force between the collecting rotating member and the substance to be collected; a removing member for coming in contact with a circumferential surface of the collecting rotating member, and removing the substance to be collected from the collecting rotating member; and a collecting portion for collecting the substance to be collected, which has been removed from the collecting rotating member by the removing member. The electrostatic collecting apparatus includes an adsorption force reducing unit for partially reducing the electrostatic adsorption force between the substance to be collected, which is borne on the collecting rotating member, and the collecting rotating member at around the circumferential surface of the collecting rotating member.

### BACKGROUND OF THE INVENTION

### Field of the Invention

The present invention relates to an apparatus for electrostatically collecting fine particles attaching onto the surface of an object.

### Description of the Related Art

Currently, technologies of collecting/removing foreign matters and unnecessary substances by using an electrostatic adsorption force in various manufacturing facilities and industrial products have been under development. For example, Japanese Patent No. 4886097 discloses the technology of collecting/removing foreign matters on a surface of an article, having a relatively higher surface smoothness such as a glass substrate, a print substrate (such as a PCB or a PCBA), a film, a sheet, or a plastic sheet, by using an electrostatic adsorption force. Further, Japanese Patent Application Publication No. 2017-156450 discloses the technology of collecting/removing a paper powder attaching onto the surface of paper in an electrophotographic image forming apparatus by using an electrostatic adsorption force. The technologies each have a configuration in which a roller or the like is applied with a voltage, thereby electrostatically adsorbing foreign matters, and the adsorbed foreign matters are scraped and collected by a scraping member such as a cleaning blade.

### SUMMARY OF THE INVENTION

However, the electrostatic collecting apparatus as described above has the following problem. Namely, when the electrostatic adsorption force is increased in order to enhance the collectability, foreign matters may continue attaching onto the roller even if an attempt is made to scrape off the foreign matters on the roller surface by a scraping member. Then, such foreign matters may be deposited, and may overflow to be reattaching to an object to be cleaned.

It is an object of the present invention to provide a technology capable of improving the collecting performance of an electrostatic collecting apparatus.

In order to attain the foregoing object, an electrostatic collecting apparatus of the present invention includes:
a collecting rotating member rotatably arranged opposed to a surface of an object to be cleaned, and to which a substance to be collected attaches; an adsorption force generating unit for generating an electrostatic adsorption force between the collecting rotating member and the substance to be collected;
a removing member for coming in contact with a circumferential surface of the collecting rotating member, and removing the substance to be collected, which is borne on the collecting rotating member, from the collecting rotating member; and
a collecting portion for collecting the substance to be collected, which has been removed from the collecting rotating member by the removing member,
wherein the electrostatic collecting apparatus includes an adsorption force reducing unit for partially reducing the electrostatic adsorption force between the substance to be collected, which is borne on the collecting rotating member, and the collecting rotating member, at around the circumferential surface of the collecting rotating member.

The present invention can improve the collecting performance of the electrostatic collecting apparatus.

Further features of the present invention will become apparent from the following description of exemplary embodiments with reference to the attached drawings.

### BRIEF DESCRIPTION OF THE DRAWINGS

FIG. 1 is a transverse cross sectional view showing an overall configuration of an image forming apparatus in accordance with Example 1;

FIG. 2 is a block view of a paper conveyance roller-cum-paper powder collecting apparatus in accordance with Example 1;

FIG. 3 is a block view of a paper conveyance roller-cum-paper powder collecting apparatus in accordance with Comparative Example;

FIG. 4 is a block view of a paper conveyance roller-cum-paper powder collecting apparatus in accordance with Example 2;

FIG. 5 is a block view of a paper conveyance roller-cum-paper powder collecting apparatus in accordance with Example 3;

FIG. 6 is a block view of a paper conveyance roller-cum-paper powder collecting apparatus in accordance with Example 4;

FIG. 7 is a block view of a paper conveyance roller-cum-paper powder collecting apparatus in accordance with Example 5;

FIG. 8 is a block view of another paper conveyance roller-cum-paper powder collecting apparatus in accordance with Example 5;

FIG. 9 is a block view of a paper conveyance roller-cum-paper powder collecting apparatus in accordance with Example 6;

FIG. 10 is a view showing the voltage waveform in accordance with Example 6;

FIG. 11 is a transverse cross sectional view showing the overall configuration of an image forming apparatus in accordance with Example 7;

FIG. 12 is a block view of a tonner collecting apparatus for an intermediate transfer belt in accordance with Example 7;

FIG. 13 is a block view of a paper powder collecting apparatus for a photosensitive drum in accordance with Example 8;

FIG. 14 is a detail view of a powder collecting apparatus for a photosensitive drum in accordance with Example 8;

FIG. 15 is a block view of a collecting apparatus in accordance with Example 9; and

FIG. 16 is a cross sectional block view of the collecting apparatus in accordance with Example 9.

### DESCRIPTION OF THE EMBODIMENTS

Below, referring to the accompanying drawings, the aspect for executing the invention will be exemplarily described in details by way of Examples. Incidentally, the dimensions, the materials, and the shapes of the constituent components described in the embodiment, the relative arrangement thereof, and the like should be appropriately changed according to the configuration of the apparatus to which the invention is applied, and various conditions thereof. Further, all of the combinations of the features described in the present embodiment are not necessarily essential for the solving means of the present invention. The constituent elements described in embodiments are strictly exemplary, and are not intended to limit the scope of the invention only thereto.

Further, the materials, the shapes, and the like of the members once described in the following explanation are also the same as those in the initial explanation in the later explanation so long as otherwise described.

### EXAMPLE 1

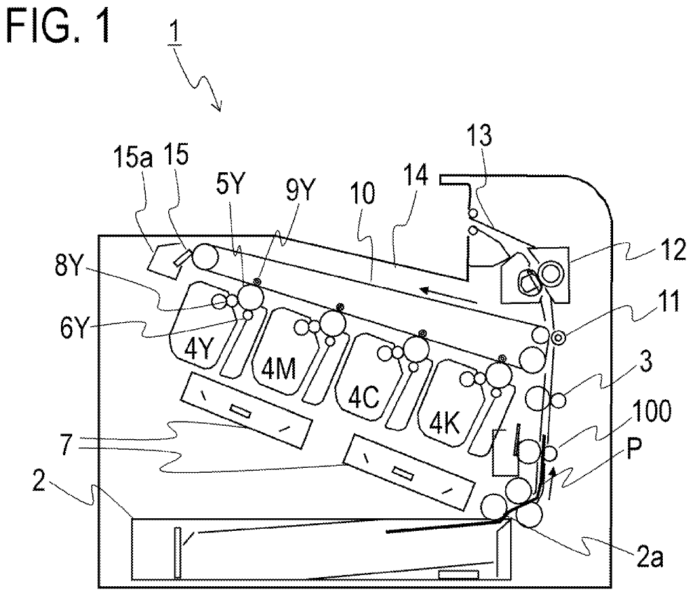

Referring to FIG. 1, a description will be given to a full color laser beam printer of an image forming apparatus in accordance with Example of the present invention. FIG. 1 is a schematic transverse cross sectional view showing the overall configuration of a full color laser beam printer 1 (which will be hereinafter referred to simply as a “printer 1”) in accordance with the present Example.

First, a description will be given to the main configuration and the operation of a printer 1. A paper cassette 2 is accommodated extractably at the lower part of the printer 1. The paper cassette 2 carries and houses sheets P as recording materials. The sheets P are separated one by one by a separating roller 2a, and are fed at a conveyance speed of 300 mm/sec by a paper conveyance roller-cum-paper powder collecting apparatus 100, and a registration roller pair 3.

The printer 1 includes image forming portions (image forming stations) 4Y, 4M, 4C, and 4K corresponding to colors of yellow, magenta, cyan, and black, respectively side by side in a row. The image forming portion 4Y includes a photosensitive drum 5Y of an image bearing member, and a charging unit 6Y for uniformly charging the surface of the photosensitive drum 5Y. Further, a scanner unit 7 for applying a laser beam in response to image information, and forming an electrostatic latent image on the photosensitive drum 5Y is provided under the image forming portion 4Y. The scanner unit 7 forms an electrostatic latent image on the photosensitive drum 5Y, and the electrostatic latent image allows a toner to attach thereto by a development unit 8Y, resulting in a toner image (developer image). The toner image is transferred to an intermediate transfer belt 10 as an intermediate transfer member at a primary transfer portion 9Y. The intermediate transfer belt 10 is rotatively driven at 300 mm/sec equal to the conveyance speed of the sheet P in an arrow direction. The process goes through the same step at the image forming portion 4M, the image forming portion 4C, and the image forming portion 4K, so that the toner images are superimposed one on another. The superimposed toner images are transferred onto the sheet P at a secondary transfer portion 11, and pass through a fixing apparatus (image heating apparatus) 12, resulting in a permanent fixed image. The sheets P pass through a discharge conveyance portion 13, and are discharged/loaded in a loading portion 14.

The toner not transferred onto the sheet P, and left on the intermediate transfer belt 10 is scraped off by a cleaning blade 15 for the intermediate transfer belt arranged so as to come in contact with the intermediate transfer belt 10, and is put into a waste toner tray 15a.

A paper powder is generated from the sheet P. The paper powder is generated in the following manner. When the sheet P is conveyed in the arrow direction, the sheet rubs with the constituent members such as a roller and a conveyance path. As a result, a pulp fiber, a filler, and the like are peeled. When the paper powder is sandwiched between the intermediate transfer belt 10 and the cleaning blade 15 for the intermediate transfer belt, slippage of the toner may be caused. For this reason, the paper powder is collected at a paper conveyance roller-cum-paper powder collecting apparatus 100, and thereby is prevented from attaching to the intermediate transfer belt 10.

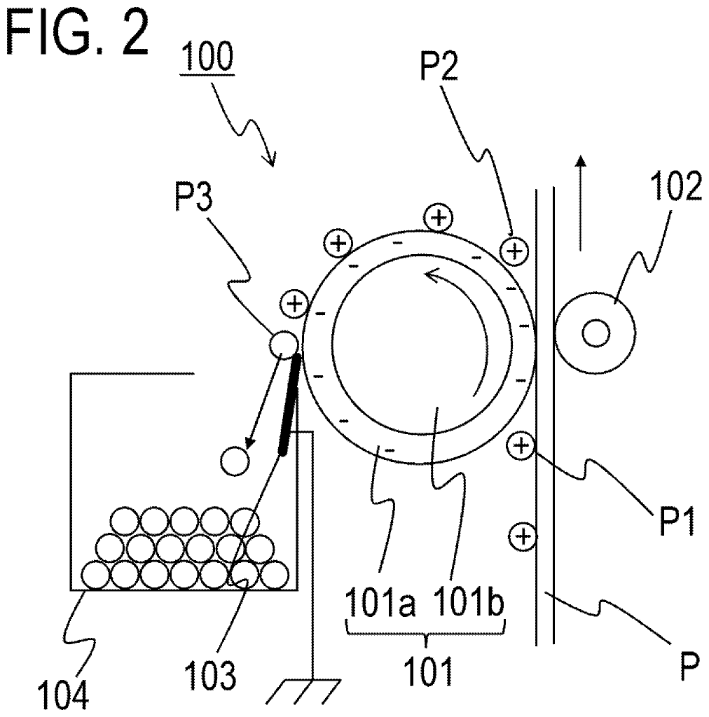

FIG. 2 is a schematic cross sectional view showing the configuration of the paper conveyance roller-cum-paper powder collecting apparatus 100 (electrostatic collecting apparatus) characteristic of the present Example, and the state in which a paper powder P1 attaching to the sheet P is collected. The object to be collected (substance to be collected) in the present Example is a paper powder, and the substance (object to be cleaned) to which an object to be collected attaches is a sheet P as recording paper. The paper conveyance roller-cum-paper powder collecting apparatus 100 includes a collecting roller 101 and an opposing roller 102, and causes the paper powder P1 attaching to the sheet P sandwiched by the collecting roller 101 and the opposing roller 102 to attach onto the surface of the collecting roller 101 by an electrostatic adsorption force for collection thereof.

The collecting roller 101 as a collecting unit (a collecting member or a collecting rotating member) includes a surface layer 101a and a shaft portion 101b, and is configured rotatably in an arrow direction shown under a driving force of a motor not shown. The surface layer 101a is formed of a fluorine resin with a thickness of 0.05 mm to 1.0 mm at the outer circumference of the shaft portion 101b. The shaft portion 101b is formed of a resin roller of polyethylene (PE), polypropylene (PP), polyvinyl chloride (PVC), polystyrene (PS), an acrylonitrile-butadiene-styrene copolymer (ABS), or the like with a diameter of about 12 mm.

The opposing roller 102 is an aluminum roller with a diameter of 8 mm, and sandwiches and conveys the sheet P with the collecting roller 101.

Herein, as the material for the surface layer 101a of the collecting roller 101, it is desirable to select the one distant in positional relationship with respect to the paper powder in the triboelectric charging series. The triboelectric charging series is the arrangement showing which one is positively charged and which one is negatively charged when friction occurs between two substances. Generally, the frictional charging amount tends to be larger, and the attachment force also tends to be higher for the substances more distant in positional relationship of the triboelectric charging series than for the substances closer in the positional relationship. The paper for use as the sheet P is on the plus side in the triboelectric charging series. For this reason, the substance distant in the positional relationship is a fluorine resin on the most minus side, and can exhibit a strong electrostatic adsorption force.

When the surface layer 101a of the collecting roller 101 including a fluorine resin and the paper powder P1 are directly rubbed with each other, both are respectively charged with opposite polarity to each other. Namely, the paper powder P1 is positively charged, and the surface layer 101a surface of the fluorine resin is negatively charged. As a result of this, both attach to each other by an electrostatic adsorption force. Further, the paper powder P1 has already been positively charged due to rubbing with the roller or the conveyance path for conveying the sheet P. In contrast, the surface layer 101a of the fluorine resin is rubbed with the sheet P to be negatively charged, thereby causing a potential difference between the surface layer 101a surface of the fluorine resin and the paper powder P1. As a result of these, the positive-polarity paper powder P1 attaching to the printing surface side as the image forming surface of the sheet P is electrostatically attracted to the surface layer 101a of the collecting roller 101, and adsorbs to the surface layer 101a surface of the collecting roller 101 from the top the sheet P.

Namely, in the present Example, the surface layer 101a of the collecting roller 101 includes a material to be charged with an opposite polarity to the charging polarity of the paper powder P1 due to rubbing with the paper powder P1, and thereby configures an adsorption force generating unit for generating an electrostatic adsorption force between the collecting roller 101 and the paper powder P1. Further, the opposing roller of a rotating member for sandwiching and conveying the sheet P as an object to be cleaned between it and the collecting roller 101 also configures an adsorption force generating unit as a member for forming a rubbing state between the collecting roller 101 and the paper powder P1.

The paper powder P2 attaching to “borne on” the surface layer 101a surface of the collecting roller 101 is scraped off by a cleaning blade (which will be hereinafter referred simply as a blade) 103 as a removing unit (removing member), and is removed from the collecting roller 101 surface. Further, the blade 103 is also an adsorption force reducing unit for region selectively (locally) reducing the electrostatic adsorption force on the collecting roller 101. The blade 103 extends in such a manner as to be toward the opposite direction to the rotation direction of the collecting roller 101 (the counter direction) from the fixed end to the free end (tip). The tip portion of a free end comes in contact with the surface layer 101a surface (circumferential surface) of the collecting roller 101. The blade 103 is arranged so as to be at an angle of 15° to 20° to the outside, so as to be more away from a tangent with approach toward the fixed end with respect to the tangent of the collecting roller 101 passing through the contact portion (contact point) with the blade 103.

The blade 103 as the adsorption force reducing unit in the present Example is a removing member having the electric conductivity including a bronze or SUS sheet with a thickness of 0.5 mm and connected to GND (grounded). The paper powder P3 which has come into contact with the blade 103 is weakened (removed) in plus electric charge (first electric charge) owned by itself due to contact with the blade 103 of a conductor, so that the attachment force with the surface layer 101a of the collecting roller 101 is reduced. Accordingly, the paper powder P3 smoothly falls into a collecting tray 104. The blade 103 and the collecting tray 104 are arranged so that the paper powder P2 which has been detached from the surface layer 101a of the collecting roller 101, and has freely fallen can be smoothly accommodated (collected) into the collecting tray 104 as a collecting portion.

Namely, only in the region in contact with the blade 103 as a first electric charge removing unit (electric charge removing member), the electrostatic adsorption force between the paper powder P3 and the collecting roller 101 is reduced, resulting in an improvement of the removing performance of the paper powder P3. Namely, around the circumferential surface of the surface layer 101a of the collecting roller 101, there are formed a first region not to be subjected to the reducing action of the electrostatic adsorption force by the adsorption force reducing unit (first electric charge removing unit), and a second region to be subjected to the reducing action of the electrostatic adsorption force by the adsorption force reducing unit. As a result of this, it is possible to combine the collecting performance (recovering performance) of the substance to be collected and the removing performance of the substance to be collected.

The collecting roller 101 is a collecting unit of a rotating member having an endless collecting surface (cleaning surface), and can repeat collection and removal of the substance to be collected for each circulation. The substance to be collected is typically the paper powder, and may include a deposit other than a paper powder such as dust.

### COMPARATIVE EXAMPLE

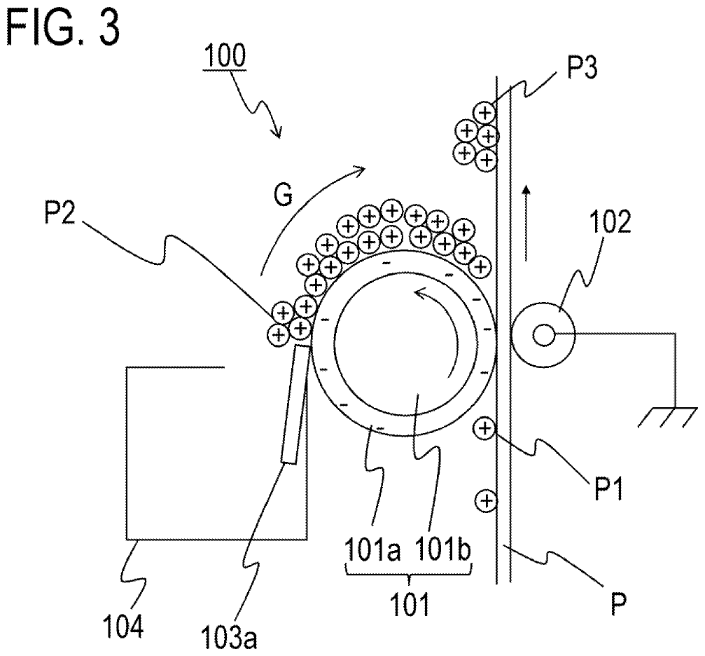

FIG. 3 is a schematic cross sectional view showing a configuration of a paper conveyance roller-cum-paper powder collecting apparatus in accordance with Comparative Example of the present Example. In order to verify the effects of the present Example, referring to FIG. 3, a description will be given to Comparative Example in which the adsorption force reducing unit does not effectively function. The basic configuration of the paper conveyance roller-cum-paper powder collecting apparatus in accordance with Comparative Example is the same as the configuration of Example 1. The blade 103a is made of urethane rubber with a thickness of 3 mm. The paper powder P2 will not be weakened in electric charge owned by itself even when it comes in contact with urethane rubber, and continues strongly attaching to the surface of the surface layer 101a of the collecting roller 101 even when it is dammed by the blade 103a. The reason for this is as follows. The surface layer 101a including a fluorine resin of the collecting roller 101 is distant in positional relationship of the triboelectric charging series with respect to the paper powder P2, and hence the frictional charging amount is large, and the attachment force is also high. When the use is continued as it is, for example, as shown in FIG. 3, the paper powder P2 is accumulated in an arrow G direction, and reattaches to the sheet P in a lump of paper powder P3. When such reattaching occurs, the paper powder P3 attaches to the intermediate transfer belt 10, and then, a paper powder attaches to the cleaning blade 15 for intermediate transfer belt, resulting in the occurrence of faulty cleaning.

Up to this point, the paper conveyance roller-cum-paper powder collecting apparatus 100 of the present Example 1 is partially reduced in electrostatic adsorption force only in the vicinity of the blade 103, thereby effectively solving the accumulation problem, and can exhibit a high electrostatic adsorption force at the portion opposed to the sheet P for collecting the paper powder P2. Accordingly, it is possible to implement combination of the improvement of the collecting performance and the removal of the substance to be collected. Further, as a result, the image forming apparatus of the present Example can prevent the paper powder from reattaching to the intermediate transfer belt 10, and also can prevent the occurrence of slippage of the toner caused by sandwiching of the paper powder between the intermediate transfer belt 10 and the cleaning blade 15 for the intermediate transfer belt.

In the Example, as a preferred embodiment of the present invention, the configuration in which the metal blade was grounded to GND was described. However, the present invention is not limited thereto. The configuration is also acceptable in which copper foil, or the like is formed on the surface of an insulator component such as an urethane blade, thereby making only the surface conductive. Further, in principle, application of a blade with a voltage (e.g., +500 V of the same polarity as that of a substance to be collected (or a substance to be recovered) such as a paper powder), or the like is also possible. As a result of this, it is also possible to apply the substance to be collected with a repulsive power, and thereby to promote the effect of tearing off the substance to be collected from the collecting roller 101.

### EXAMPLE 2

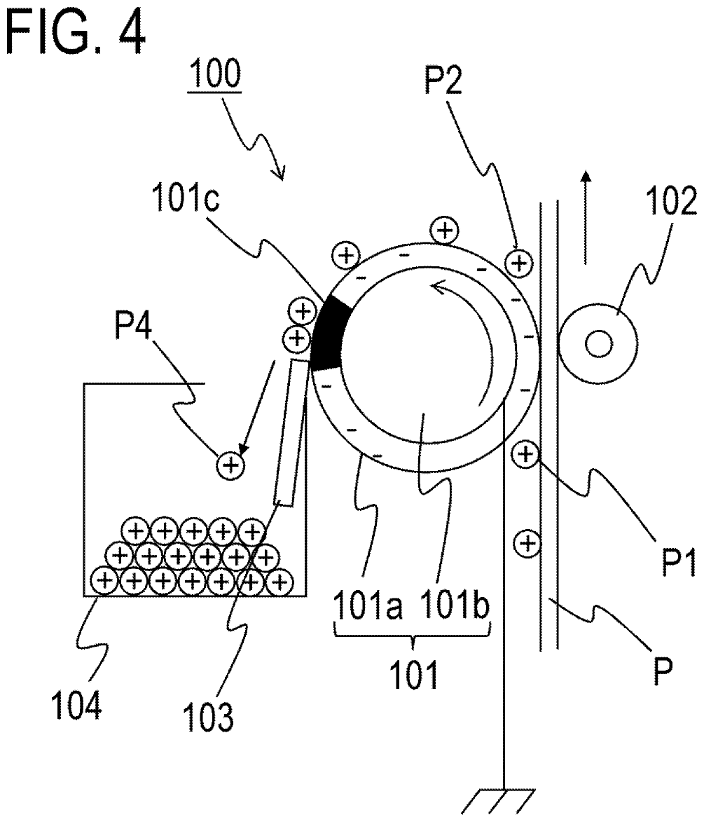

Referring to FIG. 4, a description will be given to a paper conveyance roller-cum-paper powder collecting apparatus in accordance with Example 2 of the present invention. Example 2 is characterized in that as the adsorption force reducing unit for region selectively reducing the electrostatic adsorption force of the collecting unit, a portion with a low attachment force is formed at a part of the collecting roller 101 surface layer. Below, the configurations common to Example 1 in Example 2 are given the same reference numerals and signs as those of Example 1, and will not be described. The matters herein not specified in Example 2 are the same as those in Example 1.

FIG. 4 shows the configuration of the paper conveyance roller-cum-paper powder collecting apparatus 100 in the present Example. The shaft portion 101b of the collecting roller 101 includes aluminum, and is grounded to GND. The surface layer 101a is formed of a fluorine resin with a thickness of 0.5 mm. A part of the periphery of the circumferential surface of the surface layer 101a of the fluorine resin is provided with a low resistance portion (low resistance region) 101c. The low resistance portion 101c has the same thickness as that of other portions of the surface layer 101a. The low resistance portion 101c is formed by adding titanium oxide and carbon black to a fluorine resin in order to partially reduce the resistance value in the periphery of the circumferential surface of the surface layer 101a, and suppressing charging (partially suppress an increase in charging amount).

While the surface layer 101a of the fluorine resin can be charged to -several kilovolts by rubbing with the paper powder P1, the low resistance portion 101c can be effectively reduced in surface potential (reduced in charging amount), and the charging potential due to rubbing with the paper powder P1 can be set at −500 V or less. When the surface potential is low, it becomes impossible to exhibit a strong electrostatic attachment force, so that as indicated with the paper powder P4, the paper powder can be caused to fall into the collecting tray 104 with ease.

Namely, in the present Example, the low resistance portion 101c configured as a part of the surface layer 101a of a fluorine resin of the collecting roller 101 configures a second electric charge reducing unit for partially reducing the minus electric charges (second electric charges) possessed by the surface layer 101a in the periphery of the circumferential surface. The electric charge reducing action reduces the electrostatic adsorption force between the collecting roller 101 and the paper powder.

Once per round of the collecting roller 101, the low resistance portion 101creaches the contact region with the blade 103, and the paper powder P4 falls down. The paper powder is not so large in amount, and hence, the frequency is sufficient.

Alternatively, other than the present configuration, the low resistance portion 101c may be formed of, for example, PET which is less likely to be charged, or may be formed of a metal such as aluminum.

The important point of the present configuration is that the low resistance portion 101c is less charged, and cannot exhibit a strong electrostatic attachment force. For this reason, the paper powder collecting power from the sheet P is also weakened. For this reason, it is not preferable to widen the region of 101c where the collecting power is reduced temporarily. Desirably, the site with a weak attachment force is at least 2 mm and not more than about 10% of the total relative to one round of the roller of 38 mm. With the configuration of the present Example, the site with a weak attachment force was set to 3 mm in the circumferential direction, which was 7.9% of the total.

Incidentally, the low resistance portion 101c may be provided at a plurality of sites in a dispersed manner instead of being provided at one site as in the present Example.

With the present configuration, even if the blade 103 is made of urethane rubber as in Comparative Example 1, namely, made of an insulating removing member, sufficient effects can be exhibited. Urethane rubber has high adhesiveness to the collecting roller 101 surface because of its flexibility. For this reason, it is possible to implement a higher cleaning performance than that with the configuration of Example 1.

Even when the paper powder is accumulated on the more upstream side than the tip of the blade 103 in the rotation direction of the collecting roller 101, the arrival of the low resistance portion 101c reduces the electrostatic attachment force. As a result, the paper powder can be detached from the surface layer 101a of the collecting roller 101. Namely, it becomes possible to perform recovery with the attaching position of the paper powder P2 on the surface layer 101a of the collecting roller 101 shifted from the highly charged region with a relatively larger charging amount (high potential region with a high potential) to the low charged region with a relatively smaller charging amount (low potential region with a low potential). The repeated arrival of the low resistance portion 101c keeps the amount of the paper powder P2 to be accumulated at a constant amount.

### EXAMPLE 3

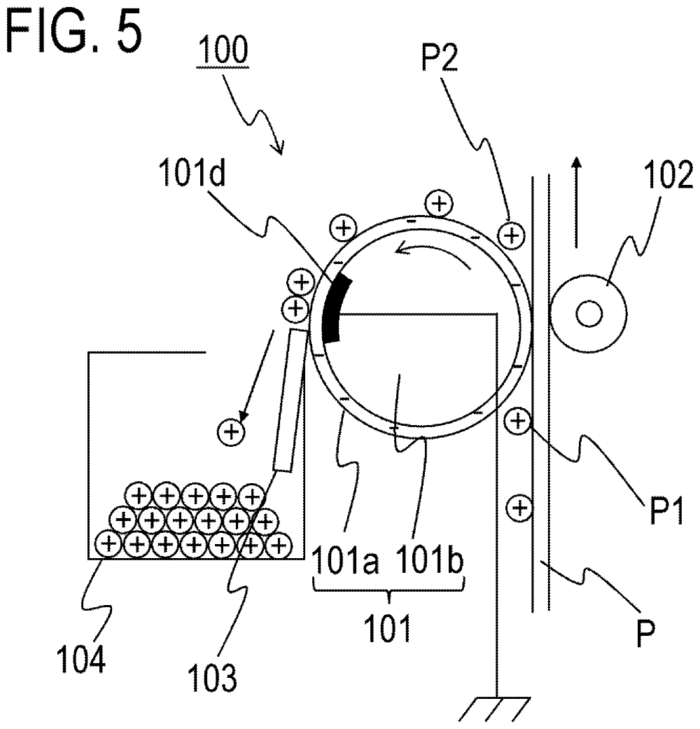

Referring to FIG. 5, a description will be given to a paper conveyance roller-cum-paper powder collecting apparatus in accordance with Example 3 of the present invention. Example 3 is characterized in that, as the adsorption force reducing unit for region selectively reducing the electrostatic adsorption force of the collecting unit, a conductor is formed at the underlying layer of the surface layer 101a of the collecting roller 101. Below, the configurations common to the Examples in Example 3 are given the same reference signs and numerals as those in the Examples, and will not be described. The matters not specified in Example 3 are the same as in the Examples.

As shown in FIG. 5, in the present Example, for the collecting roller 101 as the collecting unit, the surface layer 101a is formed of a fluorine resin with a thickness of 0.05 mm to 0.5 mm, and the shaft portion 101b with a diameter of about 12 mm is formed of an insulator resin roller of PE, PP, PVC, PS, ABS, or the like. Further, the collecting roller 101 of the present Example is provided with a metal layer 101d as a conductive layer in partial contact with a part of the inner surface (the inside) of the surface layer 101a. The material for the metal layer 101d is preferably a highly conductive material such as aluminum iron, or copper with a thickness of about 0.1 mm to 1 mm, and may be grounded to GND.

The metal layer 101d as the electric charge removing member functions as a second electric charge reducing unit for partially removing the minus electric charges (second electric charges) of the surface layer 101a. The electric charge reduced region in which minus electric charges have been removed by the metal layer 101d of the surface layer 101a goes around due to the rotation of the collecting roller 101, and reaches the rubbing region to be rubbed by the blade 103. The paper powder P2 borne in the electric charge reduced region of the surface layer 101a has been reduced in electrostatic attachment force between it and the surface layer 101a, and can be detached from the surface layer 101a (electric charge reduced region) with ease under the scraping force of the blade 103.

Further, the paper powder P2 borne in the region not in contact with the metal layer 101d (non electric charge reduced region) of the surface layer 101a may not be detached from the surface layer 101a even under the scraping force of the blade 103. However, even when such a paper powder P2 is accumulated on the more upstream side than the tip of the blade 103, the arrival of the electric charge reduced region reduces the electrostatic attachment force between it and the surface layer 101a. Accordingly, the paper powder P2 can be detached from the surface layer 101a. Namely, it becomes possible to perform collection with the attaching position of the paper powder P2 on the surface layer 101a of the collecting roller 101 shifted from the highly charged region with a relatively larger charging amount (non electric charge reduced region) to the low charged region with a relatively smaller charging amount (electric charge reduced region). The repeated arrival of the electric charge reduced region keeps the amount of the paper powder P2 to be accumulated at a constant amount.

The present configuration has the effect of locally reducing the surface potential of the surface layer 101a of a fluorine resin as in Example 2. For this reason, the attachment force of the paper powder is locally reduced, which enables the paper powder to fall into the collecting tray 104 with ease. Further, the fluorine resin tube is not required to be configured and formed so that the characteristics may change in the rotation direction as in Example 2, and can be formed more easily than in Example 2.

### EXAMPLE 4

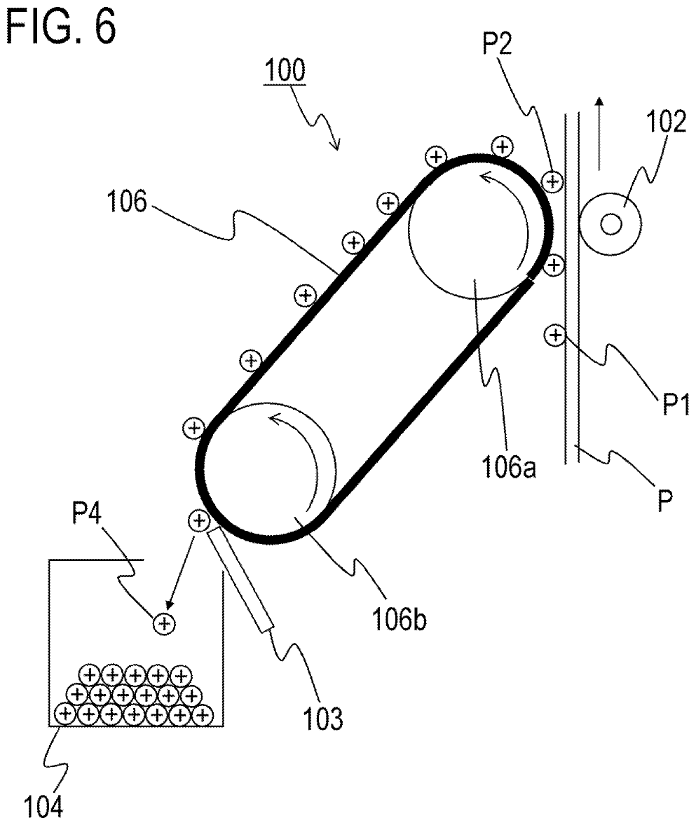

Referring to FIG. 6, a description will be given to a paper conveyance roller-cum-paper powder collecting apparatus in accordance with Example 4 of the present invention. Example 4 is characterized in that the collecting roller is formed in an endless belt, and includes a plurality of hanging rollers, and those of the hanging rollers closer to the removing unit are lower in resistance as compared with those closer to the portion in contact with the substance to which the object to be collected attaches of the hanging rollers. Below, the configurations common to the Examples in Example 4 are given the same reference signs and numerals as those in the Examples, and will not be described. The matters not specified in Example 4 are the same as in the Examples.

FIG. 6 shows the configuration of a paper conveyance roller-cum-paper powder collecting apparatus 100 in the present Example. The present configuration is based on the same principle as that of Example 3. The endless belt 106 as a collecting unit is a fluorine resin belt with a thickness of 0.05 mm to 0.5 mm, and is hung by 2 hanging rollers 106a and 106b. The hanging rollers 106a and 106b rotate in an arrow direction. The hanging roller 106a closer to the sheet P of an object to be cleaned is an insulating roller formed of a resin such as PE, PP, PVC, PS, or ABS of an insulator, and establishing a nip with the opposing roller 102. The hanging roller 106b closer to the blade 103 is a conductive roller including aluminum, iron, copper, or the like of a conductor, and presses the blade 103. Namely, the hanging roller 106b is a roller for hanging the region in which the endless belt 106 comes in contact with the blade 103. The region of the endless belt 106 made of a fluorine resin in contact with the hanging roller 106b is partially reduced in surface potential for the same reason as that of Example 3. As a result, the attachment force of the paper powder P4 is reduced, and falls into the collecting tray 104 with ease. Incidentally, the hanging roller 106b may be grounded to GND as in Example 3.

With the configuration of the present Example 4, the hanging roller 106a closer to the sheet P of an object to be cleaned is formed of an insulator. For this reason, it is possible to exhibit a strong collecting power over the entire circumference as distinct from Examples 2 and 3. Further, at a cleaning portion, it is possible to normally weaken the attachment force of the substance to be collected such as a paper powder. Accordingly, the configuration of Example 4 is the configuration advantageous for the case where there are a large number of substances to be collected.

The number of the plurality of rollers for hanging the endless belt-shaped collecting rotating member was set at 2 in the present Example, but may be 3 or more.

### EXAMPLE 5

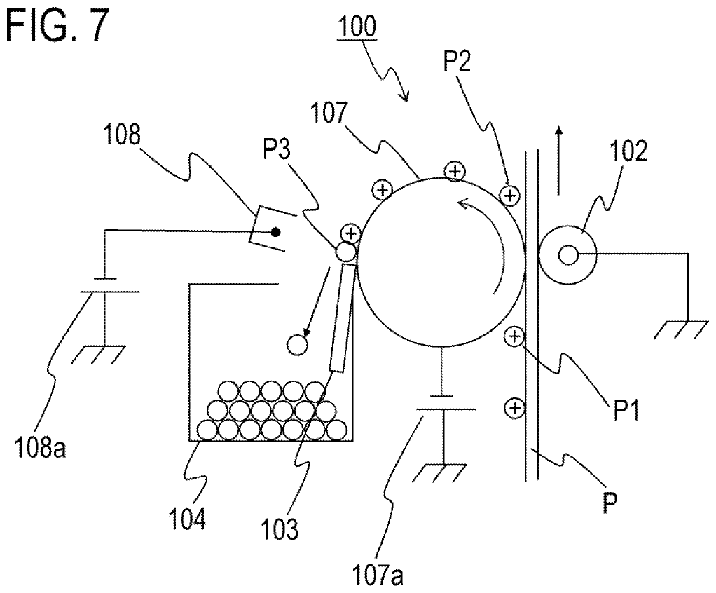

Referring to FIG. 7, a description will be given to a paper conveyance roller-cum-paper powder collecting apparatus in accordance with Example 5 of the present invention. Example 5 is characterized in that the collecting unit is a conductor, the electrostatic adsorption force is implemented by applying the collecting unit with a voltage, and the adsorption force reducing unit includes a diselectrifying unit for diselectrifying the object to be collected. Below, the configurations common to the Examples in Example 5 are given the same reference signs and numerals as those in the Examples, and will not be described. The matters not specified in Example 5 are the same as in the Examples. FIG. 7 shows the configuration of the paper conveyance roller-cum-paper powder collecting apparatus in the present Example.

The collecting roller 107 is an aluminum roller with a diameter of 12 mm, and is connected with a DC power supply (direct current power supply) 107a, and is applied with a bias of a negative polarity of about −500 V to −5 kV. Further, the opposing roller 102 arranged opposed to the collecting roller 107 is an aluminum roller with a diameter of 8 mm and is connected to GND. As a result of this, the paper powder P1 of a positive polarity is electrostatically attracted to the collecting roller 107, and is adsorbed by the collecting roller 107 from the top of the sheet P.

Subsequently, the paper powder on the collecting roller 107 is diselectrified by the action of ions generated by corona discharge by a corona charging device 108. The region to be diselectrified is the region on the downstream side of a position opposed to the surface of the paper powder P3 and on the upstream side of the position of the collecting roller 107 to come in contact with the blade 103 in a rotation direction of the collecting roller 107. The paper powder P3 reduced in plus electric charges by the corona charging device 108 as a first electric charge removing unit is scraped off by the blade 103, to be put into the collecting tray 104. The blade 103 is formed of an urethane material (insulating material) as in Example 2.

The corona charging device 108 is connected with a DC power supply 108a, and is applied with a voltage of −1 kV of the same polarity as that of the collecting roller 107. In the present configuration, as with Example 1, the plus electric charges of the paper powder P1 are reduced, thereby reducing the attachment force.

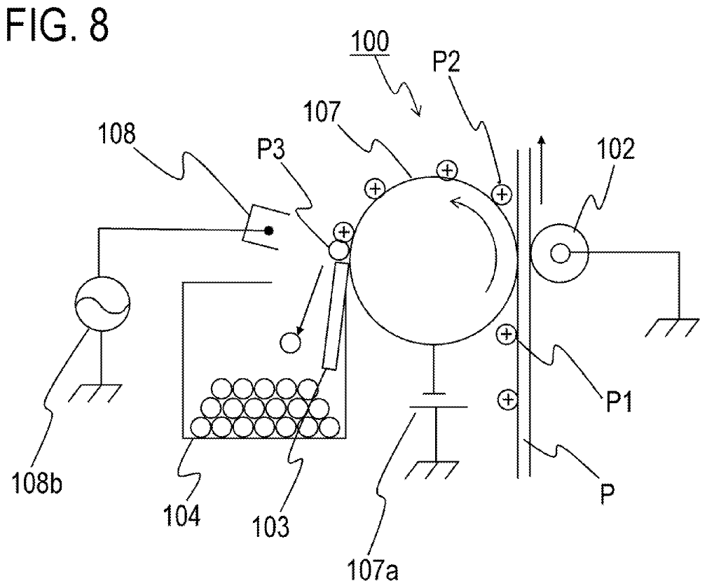

The present configuration has a higher effect with respect to a high-resistance object to be collected which is difficult to diselectrify relative to the configuration of Example 1. Then, the power supply configuration is not limited thereto. As shown in FIG. 8, an AC power supply (alternating current power supply) 108b may be used.

### EXAMPLE 6

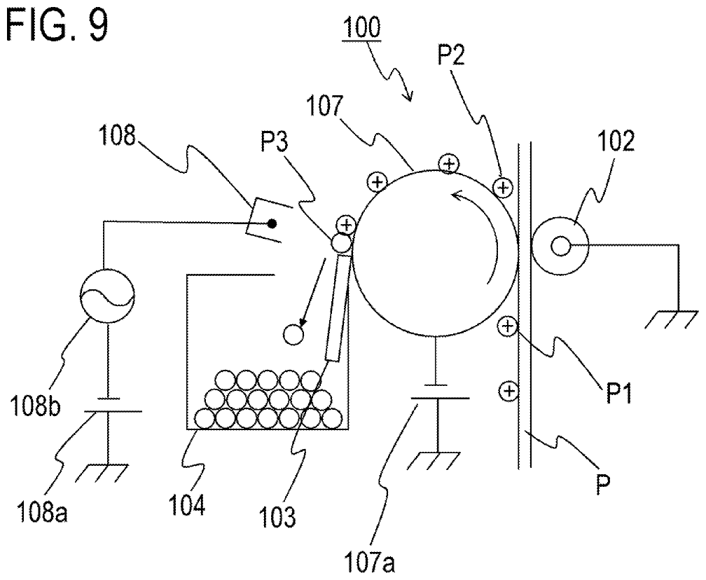

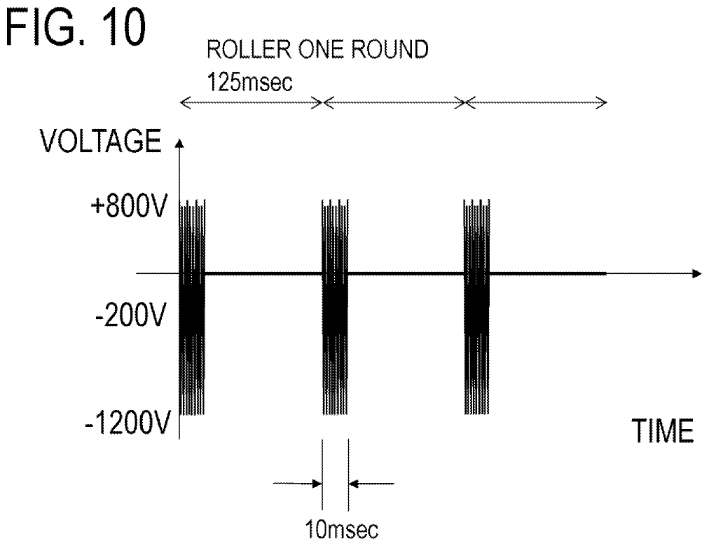

Referring to FIGS. 9 and 10, a description will be given to a paper conveyance roller-cum-paper powder collecting apparatus in accordance with Example 6 of the present invention. Example 6 is characterized in the voltage to be applied to the corona charging device 108. Below, the configurations common to the Examples in Example 6 are given the same reference signs and numerals as those in the Examples, and will not be described. The matters herein not specified in Example 6 are the same as those in the Examples.

FIG. 9 is a schematic view showing a cross sectional configuration of a paper conveyance roller-cum-paper powder collecting apparatus 100 in accordance with the present Example. In the present Example, the corona charging device 108 is connected in series with a DC power supply 108a and an AC power supply 108b as voltage applying unit. Other configurations are the same as those of Example 5.

FIG. 10 shows the waveform of the voltage. An alternating current voltage of −1000 V to +1000 V with a frequency of 1 kHz centered at −200 V is applied by repeating, for example, a period of 10-msec ON and 115-msec OFF. Namely, while a direct current voltage of a direct current power supply is normally applied, an alternating current voltage of an alternating current power supply is applied only for a prescribed period of the period corresponding to one circumference of the collecting roller 107 circumferential surface.

The reason why the application time of the alternating current voltage was restricted will be described below. The accumulation speed of the paper powder is sufficiently slow with respect to one round of the roller. For this reason, the voltage is not required to be kept being constantly applied. The paper conveyance speed of the image forming apparatus of present Example is 300 mm/sec, and the diameter of the collecting roller 101 is 12 mm. Accordingly, the roller rotation period is about 125 msec. In the present Example, a time of 10 msec equivalent to 30° relative to one round of 360° of the collecting roller 107 was assumed to be taken for every round of the roller. Further, not limited thereto, determination ON or OFF of the power supply in conjunction with the operation of the printer main body such as turning ON of the power supply at the timing of rotation after completion of one print job is also acceptable.

Namely, it is configured such that irradiation by the corona charging device 108 locally strengthens or weakens the removal of the plus electric charges of the paper powder in the region for one round of the circumferential surface of the collecting roller 107. When the paper powder attaching to the region out of the highly diselectrified region of the corona charging device 108 (low diselectrified region) is not scraped off by scraping by the blade 103, the paper powder is accumulated and remain between the blade 103 tip and the collecting roller 107 surface. For this reason, the rotation of the collecting roller 107 proceeds, so that the paper powder is included in the highly diselectrified region of the corona charging device 108. Thus, the plus electric charges are sufficiently removed, which enables detachment of the paper powder from the collecting roller 107 surface.

With the configurations of Examples 1 to 5, the time zone for reducing the attachment force could not be controlled arbitrarily. However, with the configuration of the present Example 6, the strength of the voltage can be adjusted in conjunction with the operation conditions of the apparatus such as one round of the roller, or a print job, which is advantageous from the viewpoint of energy conservation.

### EXAMPLE 7

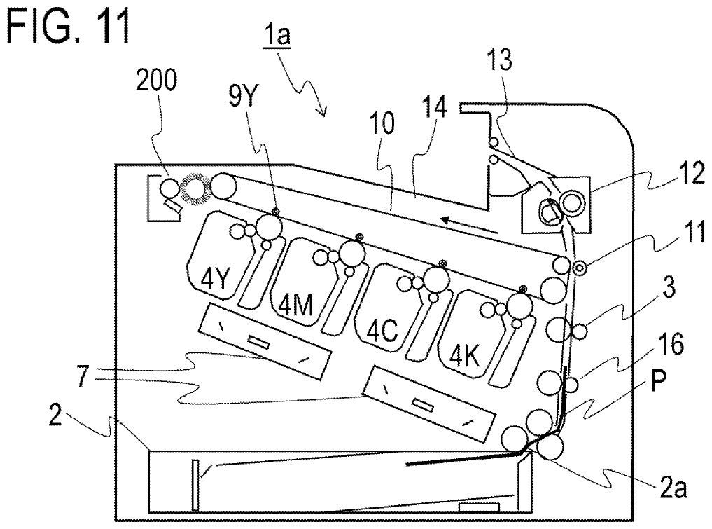

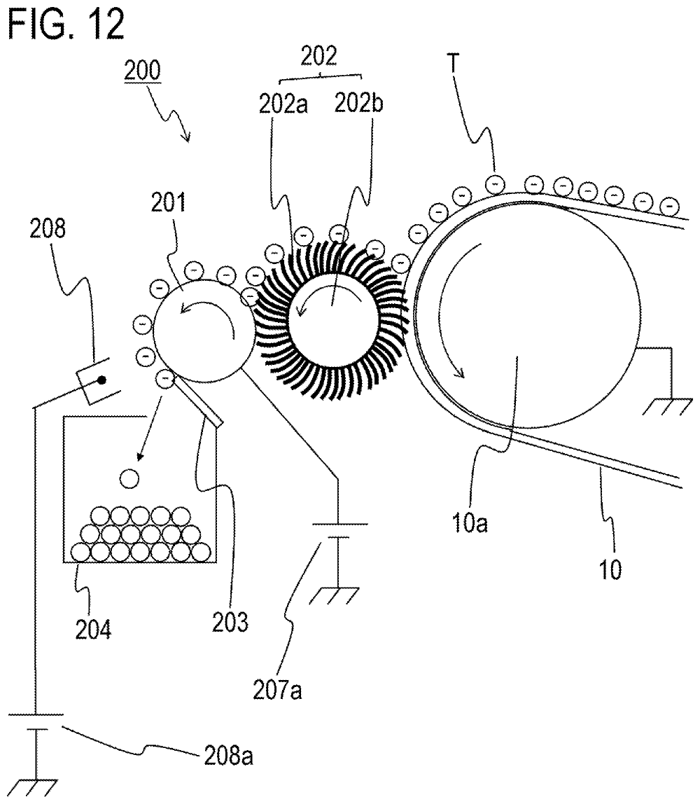

Referring to FIGS. 11 and 12, a description will be given to a toner collecting apparatus for an intermediate transfer belt in accordance with Example 7 of the present invention. In Examples 1 to 6, a description has been given to the use of collecting the paper powder from the sheet P. The electrostatic collecting apparatus of the present Example 7 is characterized in that the object to be cleaned is the intermediate transfer belt 10, and that the object to be collected of the object to be cleaned is a toner T (untransferred toner). Below, the configurations common to the Examples in Example 7 are given the same reference signs and numerals as those in the Examples, and will not be described. The matters herein not specified in Example 7 are the same as those in the Examples.

FIG. 11 is a transverse cross sectional view showing the overall configuration of a full color laser beam printer 1a (which will be hereinafter referred to simply as a “printer 1a”). The basic operation as an image forming apparatus is the same as that of the printer 1 shown in Example 1, and the same part in explanation will not be described. The toner image is transferred onto the intermediate transfer belt 10 at the primary transfer portion 9Y. The intermediate transfer belt 10 is rotatively driven in an arrow direction at 300 mm/sec. The process goes through the same step at an image forming portion 4M, an image forming portion 4C, and an image forming portion 4K, so that toner images are superimposed one on another. The superimposed toner image is transferred onto the sheet P at the secondary transfer portion 11, and passes through the image heating apparatus 12, resulting in a permanent fixed image. The toner left on the intermediate transfer belt 10 without having been transferred onto the sheet P is cleaned by a cleaning apparatus 200 for the intermediate transfer belt arranged so as to be in contact with the intermediate transfer belt 10.

FIG. 12 is a view showing the configuration of the cleaning apparatus 200 for an intermediate transfer belt characteristic of the present Example, and the state in which the residual toner T attaching to the intermediate transfer belt 10 is collected. The intermediate transfer belt 10 is hung by a hanging roller 10a, and is rotated in an arrow direction. The hanging roller 10a is formed of a conductor such as aluminum, and is set to GND. The cleaning apparatus 200 includes a collecting roller 201, a brush roller (rotary brush) 202, a blade 203, and a collecting tray (waste toner container) 204. Herein, the first object to be cleaned for the collecting roller 201 is the brush roller 202 as a brush-shaped rotating member. The brush roller 202 in in contact with the intermediate transfer belt 10 as an intermediate transfer member of the second object to be cleaned. The brush roller 202 is configured such that a brush core metal 202b made of a metal is implanted with a bristle 202a of a conductive nylon, or the like, and the brush core metal 202b is not grounded, and floats. While rotating in the arrow direction in the drawing, the brush roller 202 rubs on the intermediate transfer belt 10.

The collecting roller 201 is rotated in the arrow direction while coming in contact with the brush roller 202. The collecting roller 201 is an aluminum roller with a diameter of 12 mm as with Example 5, and is connected with a DC power supply (direct current power supply) 207a, and is applied with a bias of a positive polarity of about +500 V to +5 kV. In other words, the hanging roller 10a for hanging the intermediate transfer belt 10 is applied with a voltage via the brush core metal 202b. The voltage first causes the residual toner T of a negative polarity to be electrostatically attracted, and to adsorb to the brush roller 202 from the intermediate transfer belt 10. Then, the residual toner T is transferred onto the collecting roller 201. Subsequently, the residual toner T on the collecting roller 201 is diselectrified in minus electric charges by the corona charging device 208, and then is scraped off by the blade 203, to be put into the collecting tray 204. The blade 203 is formed of an urethan material as in Example 2. The corona charging device 208 is connected with a DC power supply 208a, and is applied with a voltage of +1 kV of the same polarity as that of the collecting roller 201.

With the present configuration, as in Example 5, by reducing the electric charges of the substance to be collected such as the residual toner T, it is possible to reduce the attachment force, and to cause the residual toner T to fall into the collecting tray 204. As a result of this, the residual toner T on the intermediate transfer belt 10 can be cleaned.

### Example 8

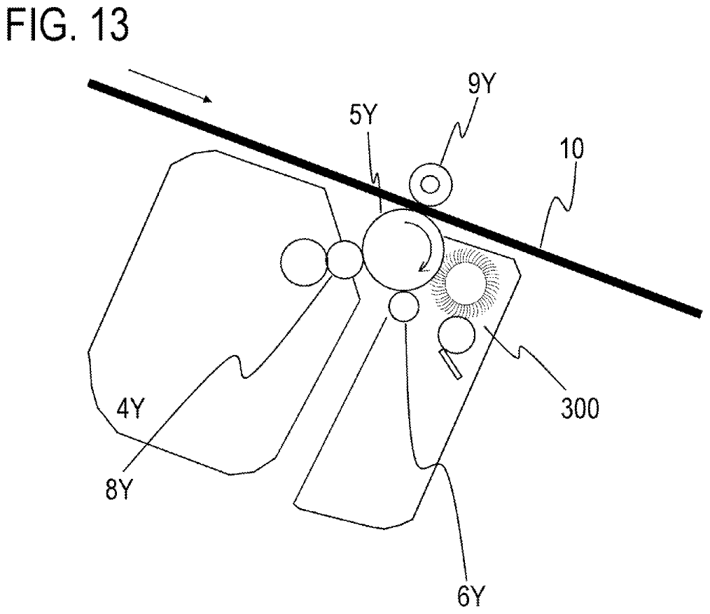

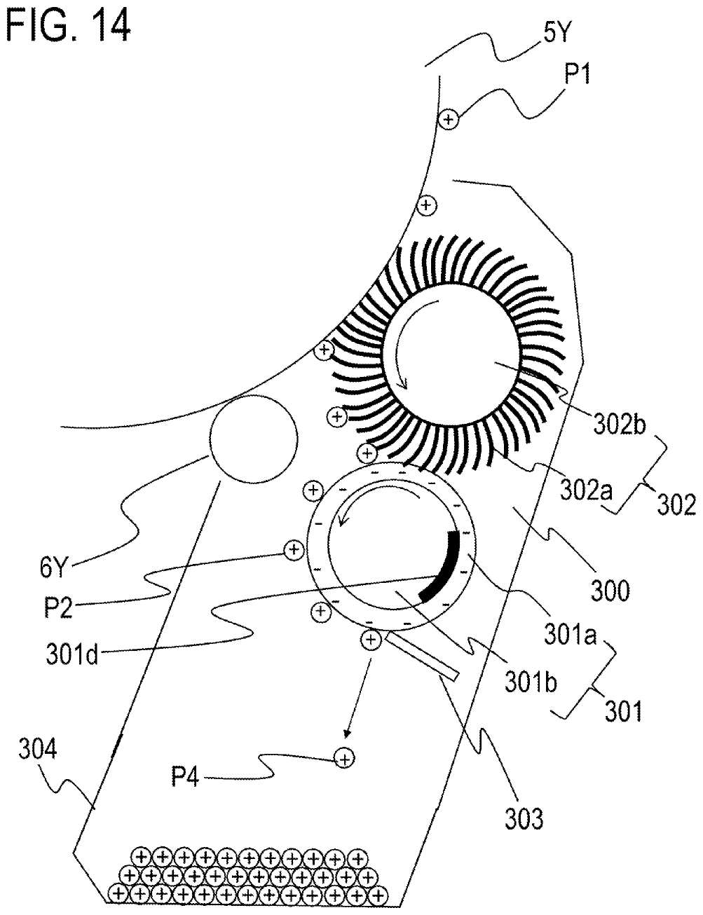

Referring to FIGS. 13 and 14, a description will be given to a paper powder collecting apparatus (cleaning apparatus) for a photosensitive drum in accordance with Example 8 of the present invention. Example 8 is different in use from Example 7. In Example 7, the residual toner T was collected from the intermediate transfer belt 10. However, the present Example 8 is characterized in that the object to be cleaned is the photosensitive drum 5Y, that the object to be collected which is to be cleaned is a paper powder, and that the paper powder collecting apparatus 300 is set in the inside of the image forming portion 4Y. Below, the configurations common to the Examples in Example 8 are given the same reference signs and numerals as those in the Examples, and will not be described. The matters herein not specified in Example 8 are the same as those in the Examples.

Although in a very small amount, the paper powder P1 may attach to the intermediate transfer belt 10, and may reach the photosensitive drum 5Y. The photosensitive drum 5Y is applied with a voltage for transferring a toner of a minus polarity onto the intermediate transfer belt 10, and hence conversely attracts the paper powder P1 of a plus polarity. The paper powder collecting apparatus 300 of the present

Example is an apparatus for collecting such a paper powder P1. Other than this, the basic operation and configuration as an image forming apparatus are the same as those of the printer 1a shown in Example 7, and the same parts will not be described in the following explanation.

FIG. 13 is a view showing the image forming portion 4Y and the paper powder collecting apparatus 300 set therein characteristic of the present Example. The paper powder collecting apparatus 300 is in contact with the photosensitive drum 5Y, and has a role of collecting the paper powder P1 conveyed attaching to the intermediate transfer belt 10 attaching to the photosensitive drum 5Y. The paper powder P1 is mostly collected at the image forming portion 4Y on the most upstream side in the rotation direction of the intermediate transfer belt 10. For this reason, even when the paper powder collecting apparatus 300 is not set positively at the image forming portions 4M, 4C, and 4K on the downstream side thereof, it is sufficiently possible to collect the paper powder P1. However, in order to more improve the collecting efficiency of the paper powder at the image forming apparatus, the paper powder collecting apparatus may be set at any of, or all of the image forming portions 4M, 4C, and 4K on the downstream side.

FIG. 14 is a view showing the details of the paper powder collecting apparatus 300. The paper powder collecting apparatus 300 is configured of a collecting roller 301, a brush roller 302, a cleaning blade 303, and a collecting tray (accommodating container) 304. Herein, the first object to be cleaned for the collecting roller 301 is the brush roller 302, and the brush roller 302 comes in contact with the photosensitive drum 5Y of the second object to be cleaned, and collects the paper powder P1 attaching to the photosensitive drum 5Y.

The brush roller 302 is obtained by implanting the core metal 302b with the brush bristle 302a, and rubs the paper powder P1 on the photosensitive drum 5Y while rotating in an arrow direction in the drawing. The material for the brush bristle 302a is formed of, for example, a fiber such as PET or a rayon yarn, and is set negatively chargeable with respect to the paper powder by the triboelectric charging series. When the brush bristle 302a and the paper powder P1 rub each other, the brush bristle 302a is negatively charged, and the paper powder is positively charged.

The surface layer 301a of a fluorine resin of the collecting roller 301 includes a member at a position more away from the paper powder P1 across the brush bristle 302ain the triboelectric charging series (in the present Example, the fluorine resin on the most minus side in the triboelectric charging series). The surface layer 301a of the fluorine resin of the collecting roller 301 is charged with the opposite polarity to that of the paper powder P1, and so that the charging amount per unit area may become larger than that of the brush bristle 302a due to the friction between the paper powder P1 and the brush bristle 302a. As a result, the surface layer 301a of the fluorine resin of the collecting roller 301 is further increased in electric potential to the minus side as compared with the brush bristle 302a, and can adsorb the paper powder P1 from the surface of the brush bristle 302a. The method goes through the processes up to this point, so that the paper powder P1 of a positive polarity attaching to the photosensitive drum 5Y is removed.

The collecting roller 301 is configured in the same manner as with the collecting roller 101 of Example 3. Namely, the surface layer 301a of the collecting roller 301 is formed of a fluorine resin with a thickness of 0.05 mm to 0.5 mm, the inside 301b is formed of a resin roller of ABS or the like with a diameter of about 12 mm, and a metal layer 301d as a conductive layer in partial contact with a part of the inside surface of the surface layer 301a is provided. The material for the metal layer 301d is preferably a highly conductive substance such as aluminum, iron, or copper, and is more preferably grounded.

Also with the present configuration, as with Example 2, the surface potential of the surface layer 301a of the fluorine resin is reduced at the contact portion with the metal layer 301d. Accordingly the attachment force of the substance to be collected such as the paper powder P1 is reduced, so that the paper powder P1 can be allowed to fall into the collecting tray 304 with ease. As a result of this, it is possible to clean the paper powder on the photosensitive drum 5Y over a long period, and the paper powder P2 will not be accumulated, and will not overflow.

### EXAMPLE 9

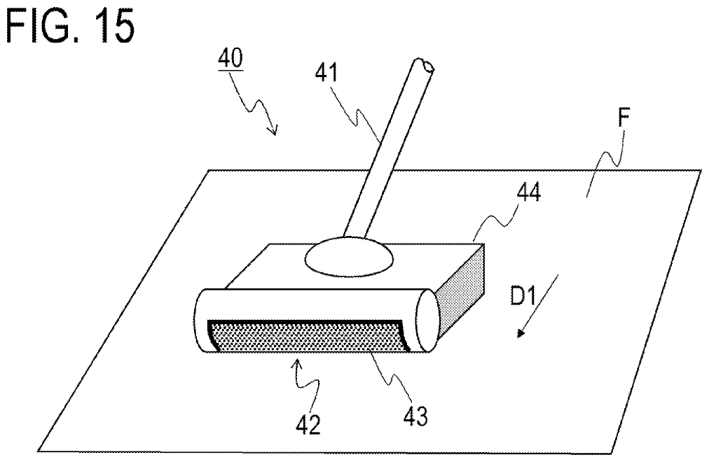

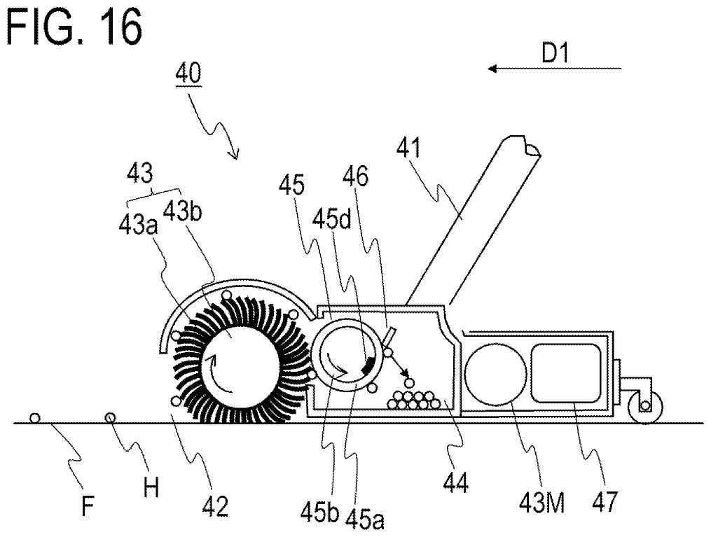

Referring to FIGS. 15 and 16, a description will be given to a collecting apparatus in accordance with Example 9 of the present invention. Example 9 is difference in uses from Examples 1 to 8. In Examples 1 to 8, the apparatus is used for finer powder collection with the image forming apparatus. The apparatus is used as a cleaning apparatus for cleaning the dust on the floor in the present Example 9. The object to be cleaned is the floor, and the object to be collected which is to be cleaned is the dust present on the floor. Below, the configurations common to the Examples in Example 9 are given the same reference signs and numerals as those in the Examples, and will not be described. The matters herein not specified in Example 9 are the same as those in the Examples.

FIG. 15 is a schematic perspective view showing the outward appearance of a cleaning apparatus in accordance with Example 9. The cleaning apparatus in accordance with the present Example is a manual cleaner 40 with which a user can perform cleaning while having a handle 41, and pushing the main body in an arrow D1 direction on a floor F of the surface to be cleaned. The main body front part of the manual cleaner 40 has an opening 42 for capturing dust, and the like, a rotary brush (collecting brush) 43 for being rotated, and scraping up dust and the like from the floor F, and a housing portion (collecting tray) 44 for housing the scraped dust H, and the like.

FIG. 16 is a schematic view showing the cross sectional configuration of the manual cleaner 40, and the state in which the dust H on the floor F is collected. The manual cleaner 40 includes a collecting roller 45, a rotary brush 43, a cleaning blade 46, and a housing portion 44. Herein, the first object to be cleaned for the collecting roller 45 is the rotary brush 43 as a brush-shaped rotating member, and the rotary brush 43 comes in contact with the floor F of the second object to be cleaned, and collects the dust H attaching to the floor F. The rotary brush 43 is rotated in the direction of an arrow in the drawing by a motor 43M and a driving transmission unit not shown. The motor 43M is supplied with a power from a battery 47, to be driven.

The rotary brush 43 is obtained by implanting a bristle 43a of insulating PET or the like into a core metal 43b, and rubs the dust H on the floor F while being rotated in an arrow direction in the drawing. The materials for the rotary brush 43 and the collecting roller 45 are designed on the basis of the same idea as that of Example 8. The dust H is mostly almost weakly positively chargeable substance. By setting the material for the collecting brush bristle 43a as PET, rayon, or the like, it is possible to positively charge, and collect the dust H.

The configuration of the collecting roller 45 is the same as that of Example 8. The surface layer 45a of the collecting roller 45 is formed of a fluorine resin with a thickness of 0.05 mm to 0.5 mm, and an inside 45b is formed of a resin roller of ABS or the like with a diameter of about 12 mm. The surface layer 45a of a fluorine resin of the collecting roller 45 further becomes larger in potential to the minus side as compared with the bristle 43a of the rotary brush 43, and can adsorb the dust H from the surface of the brush bristle 43a. Finally, the dust H on the collecting roller 45 surface is scraped off by the cleaning blade 46, and is housed in a housing portion 44. The method goes through the processes up to this point, so that the dust H of a positive polarity attaching to the photosensitive drum 5Y is removed.

The collecting roller 45 is provided with a metal layer 45d as a conductive layer in partial contact with a part of the inside surface of the surface layer 45a. The material for the metal layer 45d is preferably a highly conductive substance such as aluminum, iron, or copper, and is more preferably grounded. Also with the present configuration, as with Example 2, the surface potential of the surface layer 45a of a fluorine resin is reduced at the contact part with the metal layer 45d. For this reason, the attachment force of the substance to be collected such as the dust H is reduced, which enables easy falling of the substance to be collected into the housing portion 44. Up to this point, the manual cleaner 40 of the present Example 9 can be used comfortably without overflowing of the dust H even when continuing cleaning of the top of the floor F over a long period.

Incidentally, the configuration of the present Example is not limited to the foregoing uses, and can be used in various fields. For example, the configuration is also applicable to dust removal from a glass substrate for a display or a semiconductor wafer surface, dust removal from an electrostatic adsorbing stage surface for holding the substrate in a vacuum chamber, or the like, and can provide the same effects as those of the present Example.

For the respective Examples, their respective configurations can be combined with each other.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-003215, filed on Jan. 12, 2023, which is hereby incorporated by reference herein in its entirety.

What is claimed is:

1. An electrostatic collecting apparatus comprising:
a collecting rotating member rotatably arranged opposed to a surface of an object to be cleaned, and to which a substance to be collected attaches;
an adsorption force generating unit for generating an electrostatic adsorption force between the collecting rotating member and the substance to be collected;
a removing member for coming in contact with a circumferential surface of the collecting rotating member, and removing the substance to be collected, which is borne on the collecting rotating member, from the collecting rotating member; and
a collecting portion for collecting the substance to be collected, which has been removed from the collecting rotating member by the removing member,
wherein the electrostatic collecting apparatus includes an adsorption force reducing unit for partially reducing the electrostatic adsorption force between the substance to be collected, which is borne on the collecting rotating member, and the collecting rotating member, at around the circumferential surface of the collecting rotating member.

2. The electrostatic collecting apparatus according to claim 1, further comprising a first region and a second region around the circumferential surface,
wherein the first region is a region that does not receive a reducing action of the electrostatic adsorption force by the adsorption force reducing unit, and the second region is a region that receives the reducing action of the electrostatic adsorption force by the adsorption force reducing unit.

3. The electrostatic collecting apparatus according to claim 1,
wherein the adsorption force reducing unit is a first electric charge reducing unit capable of reducing a first electric charge having a polarity opposite to a charging polarity of the collecting rotating member of the substance to be collected.

4. The electrostatic collecting apparatus according to claim 3,
wherein the removing member comprises a material having an electric conductivity, and can remove the first electric charge from the substance to be collected by contact with the substance to be collected, and
wherein the first electric charge reducing unit is the removing member.

5. The electrostatic collecting apparatus according to claim 4, wherein the removing member is grounded.

6. The electrostatic collecting apparatus according to claim 3, further comprising
a corona charging device for reducing the first electric charge of the substance to be collected,
wherein in a rotation direction of the collecting rotating member, a region where the first electric charge is reduced on the collecting rotating member is positioned on a downstream side of a position opposed to the surface of the object to be cleaned, and is positioned on an upstream side of a position on the collecting rotating member at which the removing member comes in contact with the collecting rotating member,
wherein the first electric charge reducing unit is the corona charging device.

7. The electrostatic collecting apparatus according to claim 6,
wherein a voltage applying unit for applying a voltage to the corona charging device includes a direct current power supply and an alternating current power supply connected in series with each other, and
wherein the voltage applying unit applies an alternating current voltage of the alternating current power supply only for a prescribed period of one round of the circumferential surface of the collecting rotating member.

8. The electrostatic collecting apparatus according to claim 1,
wherein the adsorption force reducing unit is a second electric charge reducing unit, and the second electric charge reducing unit can partially reduce a second electric charge having a polarity opposite to a charging polarity of the substance to be collected of the collecting rotating member at around the circumferential surface of the collecting rotating member.

9. The electrostatic collecting apparatus according to claim 8,
wherein the circumferential surface includes a low resistance region partially reduced in resistance value such that a charging mount due to friction with the substance to be collected is partially reduced, and
wherein the second electric charge reducing unit is the low resistance region of the circumferential surface.

10. The electrostatic collecting apparatus according to claim 8,
wherein the collecting rotating member has a conductive layer in partial contact with an inner surface side of a surface layer including the circumferential surface,
wherein the surface layer has an electric charge reduced region from which the second electric charge is partially removed by the conductive layer, and
wherein the second electric charge reducing unit is the electric charge reduced region of the surface layer.

11. The electrostatic collecting apparatus according to claim 8,
wherein the collecting rotating member is an endless belt-shaped member hung by a plurality of rollers,
wherein the plurality of rollers includes a conductive roller for hanging a region in which the collecting rotating member comes in contact with the removing member,
wherein the collecting rotating member has an electric charge reduced region in which the second electric charge is partially removed by the conductive roller, and
wherein the second electric charge reducing unit is the electric charge reduced region of the collecting rotating member.

12. The electrostatic collecting apparatus according to claim 1,
wherein the circumferential surface of the collecting rotating member comprises a material to be charged with a polarity opposite to that of the substance to be collected due to friction with the substance to be collected in a triboelectric charging series, and
wherein the adsorption force generating unit is the circumferential surface of the collecting rotating member.

13. The electrostatic collecting apparatus according to claim 1, further comprising
a voltage applying unit for applying to the collecting rotating member a voltage of a polarity opposite to a charging polarity of the substance to be collected,
wherein the adsorption force generating unit is the voltage applying unit.

14. The electrostatic collecting apparatus according to claim 12, further comprising
a rotating member for sandwiching and conveying the object to be cleaned between the rotating member and the collecting rotating member,
wherein the adsorption force generating unit includes the rotating member.

15. The electrostatic collecting apparatus according to claim 1,
wherein the electrostatic collecting apparatus is used in an image forming apparatus forming an image on recording paper,
wherein the object to be cleaned is recording paper before formation of the image thereon that is conveyed at the image forming apparatus, and
wherein the substance to be collected includes a paper powder generated from the recording paper.

16. The electrostatic collecting apparatus according to claim 1,
wherein the object to be cleaned is a brush-shaped rotating member for scraping off the substance to be collected from a second object to be cleaned.

17. The electrostatic collecting apparatus according to claim 16,
wherein the electrostatic collecting apparatus is used in an image forming apparatus forming an image onto recording paper,
wherein the second object to be cleaned is an intermediate transfer member for transferring a toner image on the recording paper included in the image forming apparatus, and
wherein the substance to be collected includes a residual toner scraped off from the intermediate transfer member by the brush-shaped rotating member.

18. The electrostatic collecting apparatus according to claim 16,
wherein the electrostatic collecting apparatus is used in an image forming apparatus forming an image on recording paper,
wherein the second object to be cleaned is an image bearing member bearing a toner image and included in the image forming apparatus, and
wherein the substance to be collected includes a paper powder scraped off from the image bearing member by the brush-shaped rotating member.

19. An image forming apparatus for forming an image on recording paper, comprising the electrostatic collecting apparatus according to claim 1.

20. A cleaning apparatus comprising the electrostatic collecting apparatus according to claim 1,
wherein the object to be cleaned is a brush-shaped rotating member for scraping off the substance to be collected from a second object to be cleaned.
